(19) United States
(12) Patent Application Publication
(10) Pub. No.: US 2013/0119883 A1
(43) Pub. Date: May 16, 2013

(54) BUCK CONVERTER AND METHOD FOR PROVIDING A CURRENT FOR AT LEAST ONE LED

(71) Applicant: Bernd Rudolph, Forstern (DE)

(72) Inventor: Bernd Rudolph, Forstern (DE)

(73) Assignee: OSRAM GMBH, Muenchen (DE)

(21) Appl. No.: 13/811,409

(22) PCT Filed: Jul. 13, 2011
(86) PCT No.: PCT/EP2011/062012

§ 371 Date: Jan. 22, 2013

(30) Foreign Application Priority Data
Jul. 22, 2010 (DE) 10 2010 031 669.5

(51) Int. Cl. H05B 37/02

(52) U.S. Cl. CPC H05B 37/02
USPC 315/210

(57) ABSTRACT

A converter for providing a current for an LED includes: a buck diode, a buck inductor and a buck switch; and a first auxiliary switch, wherein the buck switch and the buck diode are coupled in series, wherein the buck inductor is coupled between the interconnection point between the buck diode and the buck switch, on one side, and a first output connection, on the other side. A reference electrode of the first auxiliary switch is coupled to a second node, at which a second voltage can be provided, which second voltage is correlated with the current provided to the LED, wherein the first auxiliary switch is coupled to the buck switch such that the disconnection time of the buck switch is fixed by the first voltage and the switch-on time of the buck switch is fixed by the sum of the first voltage and the second voltage.

### TECHNICAL FIELD

The present invention relates to a buck converter for providing a current for at least one LED including an input with a first input connection and a second input connection for coupling to a DC voltage source, an output with a first output connection and a second output connection for coupling to the at least one LED, a buck diode, a buck inductor and a buck main switch, which has a control electrode, a working electrode and a reference electrode, and a first auxiliary switch, which has a control electrode, a working electrode and a reference electrode, wherein the control electrode of the first auxiliary switch is coupled to a node at which a first voltage can be provided during operation of the circuit arrangement, which first voltage is correlated with the current provided to the at least one LED, wherein the buck main switch and the buck diode are coupled in series between the first input connection and the second input connection, wherein the buck inductor is coupled between the interconnection point between the buck diode and the buck main switch, on one side, and the first output connection, on the other side. The invention also relates to a corresponding method for providing a current for at least one LED.

### PRIOR ART

As LEDs now advance into broad sectors of general lighting, there is a considerable requirement for simple and inexpensive power supply circuits for these component parts. In the meantime, there is a large number of in particular integrated circuits which have been designed for such requirements. The modules LM3402 by the company National and the module LT3474 by the company Linear Technology are mentioned here merely by way of example. Such integrated circuits are often too expensive and too inflexible for use in mass-produced products, however. There is therefore a requirement for a power supply circuit which is as inexpensive as possible for at least one LED. An inexpensive buck converter for providing a current for at least one LED is known from WO 2009/089912 A1. Such a buck converter already enables very low realization costs and a space requirement which is below the corresponding comparison sizes in the case of a realization using an integrated circuit.

WO 2008/132658 A1 has disclosed a freely oscillating circuit arrangement which, in contrast to the abovementioned WO 2009/089912, can only operate in the critical conduction mode or in the transition mode. This document discloses the use of an amplifying transistor between a control semiconductor and a power switch semiconductor, wherein this does not represent anything other than a bipolar thyristor simulation for switching off the power switch semiconductor.

WO 2008/001246 A1 discloses a circuit arrangement for operating a load with a constant current. Said circuit arrangement includes a voltage sensor, which influences a control circuit in such a way that an effect of the change in the output voltage to the mean value of the output current is compensated for.

US 2007/0013323 A1 concerns a control circuit for the current provided to an LED and discloses the basic structure of a buck converter for operating LEDs in the continuous mode.

In respect of the further prior art, reference is made to Kelvin Ka-Shing Leung, Henry Shu-Hung Chung: “Dynamic Hysteresis Band Control of the Buck Converter with Fast Transient Response”, IEEE TRANSACTIONS ON CIRCUITS AND SYSTEMS-II: EXPRESS BRIEFS, VOL. 52, NO. 7, JULY 2005.

### DESCRIPTION OF THE INVENTION

The object of the present invention therefore consists in developing the buck converter known from WO 2009/089912 A1 and the corresponding method for providing a current for at least one LED in such a way that said buck converter and method are possible at even lower cost and with at the same time an increase in the efficiency of the buck converter.

The present invention is based on the knowledge that, given suitable driving, the first auxiliary switch and the second auxiliary switch in WO 2009/089912 A1 can be replaced by a single auxiliary switch. This results in a more cost-effective realization of such a buck converter. In addition, as will be explained in more detail below, the efficiency of the buck converter increases since the sum of the resistances of the two current measuring shunts in the realization according to the invention can be kept lower than in the case of the solution known from WO 2009/089912 A1.

Therefore, the invention provides that the reference electrode of the first auxiliary switch is coupled to a second node, at which a second voltage can be provided during operation of the circuit arrangement, which second voltage is correlated with the current provided to the at least one LED, wherein the first auxiliary switch is coupled to the buck main switch in such a way that the disconnection time of the buck main switch is fixed by the first voltage and the switch-on time of the buck main switch is fixed by the sum of the first voltage and the second voltage.

In a preferred embodiment, the sum of the first voltage and the second voltage is coupled between the control electrode and the reference electrode of the first auxiliary switch.

A preferred embodiment is characterized by the fact that the first voltage and the second voltage are dimensioned such that the first auxiliary switch transfers from the on to the off state in the freewheeling phase of the buck converter. This opens up the possibility of tapping off both the first voltage and the second voltage at nonreactive resistors, with the same current flowing through both of said nonreactive resistors in the freewheeling phase of the buck converter. The time at which the auxiliary switch transfers to the off state can thus be adjusted in a particularly simple manner by dimensioning the nonreactive resistors at which the corresponding voltage is tapped off.

Preferably, the buck converter accordingly also includes a first shunt resistor, and a second shunt resistor, wherein the voltage drop across the first shunt resistor represents the first voltage, and wherein the voltage drop across the second shunt resistor represents the second voltage. As already mentioned, by simple dimensioning of the shunt resistors it is then possible to fix when the buck main switch is switched on and off. As a result, maximum and minimum values for the current provided to the at least one LED are fixed in a simple manner.

Preferably, the first shunt resistor is arranged in such a way that the current provided to the at least one LED flows through said first shunt resistor at least in the charging phase of the buck converter. Particularly preferably, the current provided to the at least one LED flows through said first shunt resistor both in the charging phase and in the freewheeling phase of the buck converter. In this context, the first shunt resistor is coupled between the second output connection and a reference potential in a preferred exemplary embodiment. Since there is still no current flowing in the branch in which the buck diode is arranged in the charging phase of the buck converter, such an arrangement of the first shunt resistor makes it possible to adjust the maximum value of the current provided to the at least one LED. By virtue of the positioning of the first shunt resistor between the second output connection and a reference potential, the first voltage is related to the reference potential and enables particularly simple coupling to the auxiliary switch.

Preferably, the second shunt resistor is arranged in such a way that the current provided to the at least one LED flows through said second shunt resistor in the freewheeling phase, but not in the charging phase, of the buck converter. In this context, it is particularly preferred if the second shunt resistor is coupled between the buck diode and a reference potential. The advantage also results here that particularly simple coupling of the second voltage to the auxiliary switch can take place when said auxiliary switch is likewise coupled to the reference potential.

In a preferred exemplary embodiment, the first shunt resistor has a greater resistance than the second shunt resistor. As a result, the same current can flow through both the first shunt resistor and the second shunt resistor and it is nevertheless ensured that the first voltage is greater than the second voltage in the freewheeling phase of the buck converter. Thus, the first shunt resistor determines the maximum value for the current provided to the LED, while the sum of the resistances of the first and second shunt resistors fixes the minimum value for the current provided to the LED.

In accordance with one development, the buck converter includes a second auxiliary switch, which has a control electrode, a reference electrode and a working electrode, wherein the reference electrode of the second auxiliary switch is coupled to a reference potential, wherein the working electrode of the second auxiliary switch is coupled to the control electrode of the buck main switch, wherein the control electrode of the second auxiliary switch is coupled to the working electrode of the first auxiliary switch. By virtue of this measure, the first auxiliary switch first drives the second auxiliary switch, which in turn controls the buck main switch. Preferably in this case the control electrode of the second auxiliary switch is coupled to the first input connection via a nonreactive resistor. This ensures that the second auxiliary switch switches on the buck main switch on application of a DC supply voltage to the input of the buck converter in order to enable startup of the buck converter according to the invention.

Further preferably, the control electrode of the buck main switch is coupled to the first input connection via a nonreactive resistor. As a result, the depletion of the base of the buck main switch, if said buck main switch is realized as a bipolar transistor, is accelerated. Shorter switching times are thus possible.

Further preferred embodiments can be gathered from the dependent claims.

The preferred embodiments proposed with respect to the buck converter according to the invention and the advantages thereof hold true, insofar as applicable, for the method according to the invention.

### BRIEF DESCRIPTION OF THE DRAWING(S)

An exemplary embodiment of a buck converter according to the invention will now be illustrated in more detail below with reference to the attached drawing, which shows a schematic illustration of an exemplary embodiment of a buck converter according to the invention.

### PREFERRED EMBODIMENT OF THE INVENTION

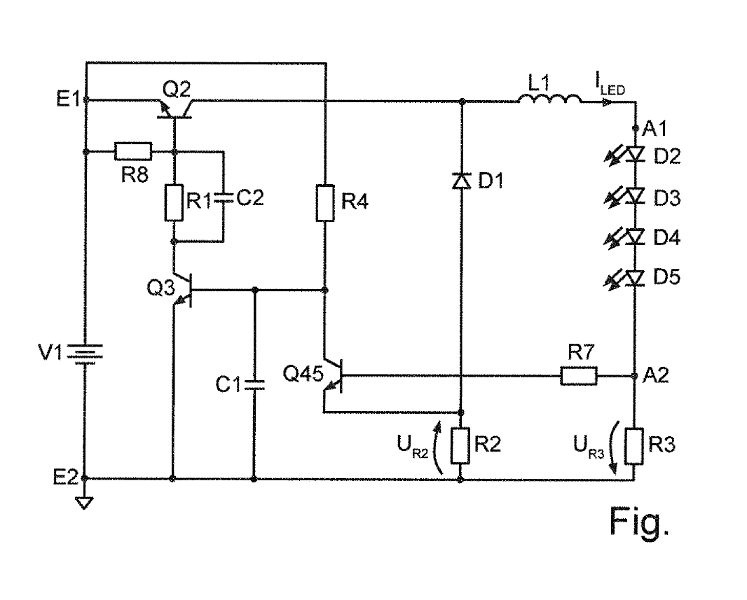

FIG. 1 shows a schematic illustration of an exemplary embodiment of a buck converter according to the invention. Said buck converter has an input with a first input connection E1 and a second input connection E2, with a low-voltage DC voltage source V1 with in this case 24V being coupled between said input connections. Although the present invention is illustrated below using the example of feeding from such a low-voltage DC voltage source, which can be in the form of a battery, for example, it is also readily possible for a system voltage (100 to 230V) to be used for the feed by virtue of connecting a device which has long been known to a person skilled in the art upstream.

The input connection E2 is coupled to a reference potential. The series circuit including a buck main switch Q2, a buck diode D1 and a nonreactive resistor R2 is coupled between the first input connection E1 and the second input connection E2. A buck inductor L1 is coupled between the interconnection point between the buck main switch Q2 and the buck diode D1, on one side, and a first output connection A1, on the other side. A plurality of LEDs D2 to D5 are coupled between the output connection A1 and a second output connection A2. A nonreactive resistor R3 is coupled between the output connection A2 and the reference potential. The voltage drop across the nonreactive resistor R3 is coupled, via a nonreactive resistor R7, to the base of an auxiliary switch Q₄₅, whose emitter is likewise connected to the reference potential via a nonreactive resistor R2, which is coupled in series with the buck diode D1. The collector of the first auxiliary switch Q₄₅ is coupled to the first input connection E1 via a nonreactive resistor R4. The node at which the nonreactive resistor R4 is coupled to the collector of the auxiliary switch Q₄₅ is coupled to the control electrode of a second auxiliary switch Q3. The emitter of the auxiliary switch Q3 is coupled to the reference potential. The capacitor C1 is coupled in parallel with the control electrode-reference electrode path of the second auxiliary switch Q3. A nonreactive resistor R8 is connected between the base of the buck main switch Q2 and the first input connection E1. Furthermore, the parallel circuit including a nonreactive resistor R1 and a capacitor C2 is coupled between the base of the buck main switch Q2 and the collector of the second auxiliary switch Q3.

In respect of the operation: once a DC voltage source V1 has been applied between the first input connection E1 and the second input connection E2, the second auxiliary switch Q3 is switched to the on state via the nonreactive resistor R4. The buck main switch Q2 is switched to the on state via the parallel circuit including the nonreactive resistor R1 and the capacitor C2 by the current flowing from the collector to the emitter of the second auxiliary switch Q3. The charging phase of the buck converter has begun. In the process, a current flows via the buck main switch Q2, through the buck inductor L1, the LEDs D2 to D5, via the nonreactive resistor R3 and the reference potential, back to the output connection E2. As long as the diode D1 is off, the emitter of the first auxiliary switch Q₄₅ is at the reference potential. Owing to the increase in the load current I_{LED}, the voltage drop U_{R3} across the nonreactive resistor R3, in the event that the base-emitter threshold voltage of the first auxiliary switch Q₄₅ of approximately 0.6V is exceeded, until now results in the first auxiliary switch Q₄₅ being switched to the on state. As a result, the base current provided previously via the nonreactive resistor R4 at the second auxiliary switch Q3 is conducted via the first auxiliary switch Q₄₅ to the reference potential. As a result, the second auxiliary switch Q3 transfers to the off state, as a result of which the buck main switch Q2 is switched off. The freewheeling phase of the buck converter has begun.

In the freewheeling phase, a current flows from the reference potential via the nonreactive resistor R2, the buck diode D1, the buck inductor L1 and the LEDs D2 to D5 and the nonreactive resistor R3 back to the reference potential. By virtue of the voltage drop U_{R2} across the nonreactive resistor R2, first the first auxiliary switch Q₄₅ is switched to conduct even more. Since the current I_{LED} now decreases owing the demagnetization of the buck inductor L1, the base-emitter voltage U_{BE} of the first auxiliary switch Q₄₅ decreases, as follows:

U_{BE}(Q₄₅)=(R2+R3)·I_{LED}

If the voltage U_{BE} of Q3 decreases below the threshold voltage of 0.6V, the first auxiliary switch Q₄₅ transfers to the off state. As a result, the second auxiliary switch Q3 can be switched on again via the nonreactive resistor R4, as a result of which the buck main switch Q2 is switched on.

Accordingly, the upper limit value for the current I_{LED} is determined as:

I_{LEDmax}=U_{BEF}(Q₄₅)/R3

and the lower limit value for the LED current is determined as:

I_{LEDmin}=U_{BEF}(Q₄₅)/(R2+R3)

The frequency of the triangular current I_{LED} is determined by the input voltage V1, the voltage drop across the LEDs D2 to D5, the inductance of the buck inductor L1 and the limit values for the minimum LED current I_{LEDmin} and the maximum LED current I_{LEDmax}.

The switch Q₄₅ is operated in the base circuit, which represents the quickest of the three basic circuits. Therefore, it also does not make any sense to select quick types for the switches Q2 and Q3. In this context, the switch Q2 can expediently be realized as a MOSFET. A high continuous switching speed of the switches of the buck converter enables a further improvement in the efficiency and/or higher switching frequencies, associated with a reduction in the physical size of the inductance L1.

In comparison with the buck converter from WO 2009/089912, the nonreactive resistor R2 of the present buck converter is as follows:

R2(present invention)=R2(WO 2009/089912)−R3(WO 2009/089912)

Thus, the value for the nonreactive resistor R2 has been markedly reduced in comparison with the value known from WO 2009/089912 for the nonreactive resistor R2. This results in significantly lower losses, as a result of which the efficiency of the present buck converter is increased over the known buck converter. In this context, the particular point should be made that the load circuit current I_{LED} flows through the nonreactive resistor, with the result that even the lowest reductions in the resistance value result in an increase in the efficiency.

1. A buck converter for providing a current for at least one light emitting diode, comprising
an input with a first input connection and a second input connection for coupling to a DC voltage source;
an output with a first output connection and a second output connection for coupling to the at least one light emitting diode;
a buck diode, a buck inductor and a buck main switch, which has a control electrode, a working electrode and a reference electrode; and
a first auxiliary switch, which has a control electrode, a working electrode and a reference electrode,
wherein the control electrode of the first auxiliary switch is coupled to a node at which a first voltage can be provided during operation of the circuit arrangement, which first voltage is correlated with the current provided to the at least one light emitting diode,
wherein the buck main switch and the buck diode are coupled in series between the first input connection and the second input connection, wherein the buck inductor is coupled between the interconnection point between the buck diode and the buck main switch, on one side, and the first output connection, on the other side;
wherein the reference electrode of the first auxiliary switch is coupled to a second node, at which a second voltage can be provided during operation of the circuit arrangement, which second voltage is correlated with the current provided to the at least one light emitting diode, wherein the first auxiliary switch is coupled to the buck main switch in such a way that the disconnection time of the buck main switch is fixed by the first voltage and the switch-on time of the buck main switch is fixed by the sum of the first voltage and the second voltage.

2. The buck converter as claimed in claim 1,
wherein the first voltage and the second voltage are dimensioned such that the first auxiliary switch transfers from the on to the off state in the freewheeling phase of the buck converter.

3. The buck converter as claimed in claim 1,
wherein the sum of the first voltage and the second voltage is coupled between the control electrode and the reference electrode of the first auxiliary switch.

4. The buck converter as claimed in claim 1,
wherein the buck converter furthermore comprises:
a first shunt resistor; and
a second shunt resistor,
wherein the voltage drop across the first shunt resistor represents the first voltage, and wherein the voltage drop across the second shunt resistor represents the second voltage.

5. The buck converter as claimed in claim 4,
wherein the first shunt resistor is arranged in such a way that the current provided to the at least one light emitting diode flows through said first shunt resistor at least in the charging phase of the buck converter.

6. The buck converter as claimed in claim 5,
wherein the first shunt resistor is coupled between the second output connection and a reference potential.

7. The buck converter as claimed in claim 4,
wherein the second shunt resistor is arranged in such a way that the current provided to the at least one light emitting diode flows through said second shunt resistor in the freewheeling phase, but not in the charging phase, of the buck converter.

8. The buck converter as claimed in claim 7,
wherein the second shunt resistor is coupled between the buck diode and a reference potential.

9. The buck converter as claimed in claim 4,
wherein the first shunt resistor has a greater resistance than the second shunt resistor.

10. The buck converter as claimed in claim 1,
wherein the buck converter comprises a second auxiliary switch, which has a control electrode, a reference electrode and a working electrode, wherein the reference electrode of the second auxiliary switch is coupled to a reference potential, wherein the working electrode of the second auxiliary switch is coupled to the control electrode of the buck main switch, wherein the control electrode of the second auxiliary switch is coupled to the working electrode of the first auxiliary switch.

11. The buck converter as claimed in claim 1,
wherein the control electrode of the second auxiliary switch is coupled to the first input connection via a nonreactive resistor.

12. The buck converter as claimed in claim 1,
wherein the control electrode of the buck main switch is coupled to the first input connection via a nonreactive resistor.

13. A method for providing a current for at least one light emitting diode by means of a buck converter, which comprises an input with a first input connection and a second input connection for coupling to a DC voltage source; an output with a first output connection and a second output connection for coupling to the at least one light emitting diode; a buck diode, a buck inductor and a buck main switch, which has a control electrode, a working electrode and a reference electrode, and a first auxiliary switch, which has a control electrode, a working electrode and a reference electrode, wherein the control electrode of the first auxiliary switch is coupled to a node, at which a first voltage can be provided during operation of the circuit arrangement, which first voltage is correlated with the current provided to the at least one light emitting diode wherein the buck main switch and the buck diode are coupled in series between the first input connection and the second input connection, wherein the buck inductor is coupled between the interconnection point between the buck diode and the buck main switch, on one side, and the first output connection, on the other side;
the method comprising:
a) coupling the first auxiliary switch to the buck main switch;
b) supplying the first voltage to the control electrode of the first auxiliary switch; and
c) supplying a second voltage, which is correlated with the current provided to the at least one light emitting diode, to the reference electrode of the first auxiliary switch;
wherein, in a), the first auxiliary switch is coupled to the main switch in such a way that the disconnection time of the buck main switch is fixed by the first voltage and the switch-on time of the buck main switch is fixed by the sum of the first voltage and the second voltage.
